(19) United States
(12) Patent Application Publication
(10) Pub. No.: US 2005/0281585 A1
(43) Pub. Date: Dec. 22, 2005

(54) Maintenance method of medical recording apparatus and cleaning sheet

(75) Inventors: Mamoru Umeki, Tokyo (JP); Makoto Sumi, Tokorozawa-shi (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Medical & Graphic, Inc., Tokyo (JP)

(21) Appl. No.: 11/148,858

(22) Filed: Jun. 9, 2005

(30) Foreign Application Priority Data
Jun. 16, 2004 (JP) JP2004-178151

(51) Int. Cl. G03G 15/20

(52) U.S. Cl. 399/123

(57) ABSTRACT

A cleaning method of a medical recording apparatus includes the steps of opening the vicinity of an adhesive roller by a cover unit; engaging a cleaning sheet with the adhesive roller, the sheet having an greater adhesive force than the adhesive force of the adhesive roller; rotating the adhesive roller, while keeping the engagement; transferring foreign matters from the surface of the adhesive roller to the cleaning sheet, while conveying the cleaning sheet; and removing the cleaning sheet with the foreign matters. A cleaning sheet for cleaning an adhesive roller of a medical recording apparatus includes a flexible sheet-formed base; an adhesive layer formed on a surface of the base to make an adhesive surface to adsorb foreign matters form the adhesive roller; and an auxiliary member provided on the adhesive surface at a side-edge of the base to improve rigidity of the base.

This application is based on Japanese Patent Application No. 2004-178151 filed on Jun. 16, 2004, in Japanese Patent Office, the entire content of which is hereby incorporated by reference.

### FIELD OF THE INVENTION

The present invention relates to a meintenance method of a medical recording apparatus having a built-in adhesive roller for cleaning a surface of a film, and relates to a cleaning sheet for the adhesive roller.

### BACKGROUND OF THE INVENTION

In a typical sheet conveying system, if paper dust and the like, created through conveying sheets, adhere to a roller, the friction coefficient of the roller drops, which may cause a conveyance jam. As a solution to overcome this problem, Patent Document 1, described below, discloses a method of cleaning a roller of a conveying system in a device by conveying a sheet, in the device, having an adhesive layer on its one surface for removing paper dust from a roller (that is, cleaning the roller) and by ejecting the sheet.

Further, Patent Document 2, described below, discloses a method of stabilizing conveyance of a cleaning sheet by setting the surface roughness of the sheet on the side opposite to an adhesive layer in a certain range.

Still further, Patent Document 3, described below, discloses employing a film having a characteristic that prevents easy adhesion of foreign matters, because in a medical laser imager or the like, foreign matters adhered to a film emulsion side tend to show an appearance of white spots (not exposed) on a finished film. Hereinafter in this specification, “foreign matters” include dust.

Yet further, Patent Document 4, described below, discloses a method of removing foreign matters in a conveying system by conveying an adhesive cleaning sheet in the conveying system and ejecting the sheet, because not only in a typical exposure system but also in a recording device of a thermal transfer type, foreign matters present in a recording medium conveying system and a transfer sheet conveying system generate white spots (image defects).

Further developing the method of dust removal, Patent Document 5, described below, discloses a method of cleaning the surface of a conveying roller by controlling an adhesive roller position relative to a conveying roller in a device. Still further, Patent Document 6, described below, discloses a method of removing foreign matters adhered on the surface of a conveyed medium (sheet) by engaging an adhesive roller directly with the conveyed medium conveyed in a device.

In the medical field, particularly in mammary diagnosis, an object of diagnosis is a micro calcification similar to a white spot, as described above. Accordingly, it is known that removal of image defects (white spots) present in an image read from a photostimulable phosphor plate or in a finished film image is a significant factor which affects the accuracy in diagnosis (see Patent Document 7).

In other words, a method, applied to business machines, of cleaning a conveying system with an adhesive sheet or the like in a predetermined cycle is insufficient for a medical device. For a medical device, a method by always removing foreign matters with a built-in adhesive roller is more preferable.

A method for an apparatus having a built-in adhesive roller has not a serious problem with initial performance. However, if the adhesive roller continues to adsorb foreign matters, the foreign matters once adsorbed will finally adhere to sheet-formed films or the like. Therefore, maintenance (removal of dust and foreign matters from the adhesive roller) is necessary before finished images come to be affected.

As a solution for this problem, offered is a method which extends the time from initial operation to the time when finished images come to be affected as described above, by having a transfer roller for transferring foreign matters from an adhesive roller act on the surface of the adhesive roller. Herein, the transfer roller has an adhesive force greater than that of the adhesive roller.

However, this method has the following problem. (1) Finally, maintenance of the transfer role is necessary. (2) During normal operation, it is necessary to use a pressure contact releasing mechanism for releasing the pressure contact of the transfer roller, in order to reduce a load on a driving system, for which the mechanism will be complex. (Accordingly, maintenance of the transfer roller will require more hours, including uninstall of the transfer roller.) (3) Without a pressure contact releasing mechanism, there are concerns that the adhesive roller and the transfer roller may adhere to each other during when the device is not in operation. Thus, the adhesive forces of both are lowered, resulting in a drop in the original performance of adsorbing foreign matters. (4) As it is necessary to perform cleaning by the use of flowing water in order to remove dust and foreign matters adhered to the transfer roller, the transfer roller cannot be installed on the device again before the roller gets dry. (5) Wiping the surface of the transfer roller manually with a cloth or the like causes problems of difficulty in quantification of the task and easy generation of cleaning irregularities which would be transferred to finished films when the device is operated again.

(Patent Document 1) TOKKAIHEI No. 05-69654

(Patent Document 2) TOKKAIHEI No. 10-129078

(Patent Document 3) TOKKAI No. 2004-12587

(Patent Document 4) TOKKAIHEI No. 06-328742

(Patent Document 5) TOKKAI No. 2002-220128

(Patent Document 6) TOKKAI No. 2002-337370

(Patent Document 7) TOKKAIHEI No. 10-133309

### SUMMARY OF THE INVENTION

To solve problems, such as described above, an object of the present invention is to provide a method of maintenance, of a medical recording apparatus having a built-in adhesive roller, that enables cleaning of the adhesive roller by a user during a short time and quick resumption of Operation without generation of irregularities after cleaning, and provide a cleaning sheet applicable in this method.

Such an object as described above can be attained by structures as follows.

In a first aspect of the invention, there is provided a cleaning method of a medical recording apparatus, as follows.

The apparatus which the method is applied to includes a film loading unit for holding a stack of photosensitive sheet films and feeding each sheet film one at a time; a conveying unit for conveying each sheet film, the conveying unit including an adhesive roller which has an adhesive force and works as removing foreign matters from a surface of the sheet film; an exposure unit for forming a latent image corresponding to a diagnosis image signal on the surface of each conveyed sheet film; and a cover unit capable of keeping the film loading unit, the conveying unit, and the exposure unit in a light shielded state, and capable of opening a vicinity of the adhesive roller of the conveying unit.

The method in the first aspect of the invention includes the steps of: opening the vicinity of the adhesive roller by the cover unit; engaging a cleaning sheet with the adhesive roller, wherein the cleaning sheet has an adhesive surface on at least one side of the cleaning sheet which applies a greater adhesive force than the adhesive force of the adhesive roller; rotating the adhesive roller, while keeping the engagement for conveying the cleaning sheet; transferring the foreign matters from the adhesive roller which have adhered to the roller informing the latent image on each sheet film, to the surface of the cleaning sheet during the conveyance of the cleaning sheet; and removing the cleaning sheet with the foreign matters.

In a second aspect of the invention, there is provided a cleaning sheet as follows.

A cleaning sheet in accordance with the invention is used to clean an adhesive roller which is provided in a conveying system, of a medical recording apparatus, for conveying a photosensitive film sheet or a photostimulable phosphor sheet and is capable of transferring and removing foreign matters adhered to the film sheet or the phosphor sheet. The cleaning sheet includes a flexible sheet-formed base having a flexibility to follow a surface of the adhesive roller along an axis direction of the adhesive roller, an adhesive layer formed on at least one surface of the flexible sheet-formed base to make an adhesive surface, and an auxiliary member provided on the adhesive surface along at least one side-edge of the flexible sheet-formed base with a predetermined width to improve rigidity of the flexible sheet-formed base.

### BRIEF DESCRIPTION OF THE DRAWINGS

FIG. 1 is a front view showing a main part of a medical recording apparatus in an embodiment;

FIG. 2 is a schematic diagram showing an exposure section of the medical recording apparatus in FIG. 1;

FIG. 3 is a perspective view showing a main part in a state where a side cover member is released from a housing of the medical recording apparatus in FIG. 1;

FIG. 4 is a schematic side view of pairs of conveying rollers;

FIG. 5A is a perspective view of a cleaning sheet in the present embodiment;

FIG. 5B is a fragmental enlarged sectional view of the cleaning sheet in the present embodiment; and

FIG. 6 is a side view showing a main part in a state where a pair of conveying rollers is cleaned by the cleaning sheet in FIG. 5.

### DETAILED DESCRIPTION OF THE PREFERRED EMBODIMENT

The invention includes the following methods and structures.

A cleaning method of a medical recording apparatus is provided as follows.

The apparatus which the method is applied to includes a film loading unit for holding a stack of photosensitive sheet films and feeding each sheet film one at a time; a conveying unit for conveying each sheet film, the conveying unit including an adhesive roller which has an adhesive force and works as removing foreign matters from a surface of the sheet film; an exposure unit for forming a latent image corresponding to a diagnosis image signal on the surface of each conveyed sheet film; and a cover unit capable of keeping the film loading unit, the conveying unit, and the exposure unit in a light shielded state, and capable of opening a vicinity of the adhesive roller of the conveying unit.

The above described method of the invention includes the steps of: opening the vicinity of the adhesive roller by the cover unit; engaging a cleaning sheet with the adhesive roller, wherein the cleaning sheet has an adhesive surface on at least one side of the cleaning sheet which applies greater adhesive force than the adhesive force of the adhesive roller; rotating the adhesive roller, while keeping the engagement for conveying the cleaning sheet; transferring the foreign matters from the adhesive roller which have adhered to the roller in forming the latent image on each sheet film, to the surface of the cleaning sheet during the conveyance of the cleaning sheet; and removing the cleaning sheet with the foreign matters.

According to this cleaning method of a medical recording apparatus, a cleaning sheet, which is contactable with a built-in adhesive roller and has an adhesive layer on at least one surface, is engaged with the adhesive roller and conveyed for a predetermined distance. In such a manner, the surface of the adhesive layer of the cleaning sheet is in close contact with the surface of the adhesive roller, and accordingly, foreign matters adhered to the surface of the adhesive roller are transferred to the cleaning sheet. Then, the cleaning sheet is removed. Thus, the surface of the adhesive roller can be uniformly cleaned, and a user is allowed to carry out cleaning of the adhesive roller which is built in the medical recording apparatus, during a short time period, and quickly resume operation without causing nonuniformity after cleaning.

In the cleaning method of a medical recording apparatus described above, the engagement between the cleaning sheet and the adhesive roller is preferably released after transfer of the foreign matters to the cleaning sheet.

Further, if the adhesive roller of the medical recording apparatus also has a nip roller function to convey each photosensitive film, it is possible to perform cleaning without uninstalling the adhesive roller, allowing easy cleaning.

Still further, the adhesive roller can be rotated in normal and reverse directions after the cleaning sheet and the adhesive roller are engaged with each other, and rotated relatively slowly. Consequently, foreign matters and the like can be efficiently transferred from the adhesive roller to the cleaning sheet and thus removed.

Preferably, the adhesive roller is disposed to come in contact with a latent-image forming surface of a film on which to form a latent-image so that foreign matters on the latent-image forming surface can be removed and image defects can be prevented, such as white spots in a finished image which may affects the accuracy in diagnosis.

A cleaning sheet in accordance with the invention is used to clean an adhesive roller which is provided in a conveying system, of a medical recording apparatus, for conveying photosensitive film sheets or photostimulable phosphor sheets, and is capable of transferring and removing foreign matters adhered to the film sheets or the phospher sheets. The cleaning sheet includes a flexible sheet-formed base having a flexibility to follow a surface of the adhesive roller in an axis direction of the adhesive roller, an adhesive layer formed on at least one surface of the flexible sheet-formed base to make an adhesive surface, and an auxiliary member provided on the adhesive surface along at least one side-edge of the flexible sheet-formed base with a predetermined width to improve rigidity of the flexible sheet-formed base.

By engaging the adhesive surface, which is arranged on at least one side of this cleaning sheet, with the adhesive roller such that the adhesive surface of the cleaning sheet is in close contact with the surface of the adhesive roller, it is possible to transfer foreign matters adhered to the surface of the adhesive roller to the adhesive surface of the cleaning sheet, and then remove the cleaning sheet. Thus, the surface of the adhesive roller can be uniformly cleaned, and the user is allowed to carry out cleaning of the adhesive roller which is built in the medical recording apparatus during a short time period and quickly resume operation without causing nonuniformity after cleaning.

The surface of the auxiliary member of the cleaning sheet mentioned above is preferably slidable on a top surface to have surface releasability, by which the cleaning sheet can be easily released from the adhesive roller after contact with it, enabling easy handling.

Further, the auxiliary member is preferably sticking out from the adhesive surface at the edge portion to prevent the adhesive surface of the cleaning sheet from adhering to a part other than the surface of the adhesive roller in engaging the sheet with the adhesive roller, thus avoiding difficulty in handling.

Preferably, the cleaning sheet has a cover sheet for covering the adhesive surface, wherein the cover sheet can be removed so that the adhesive surface can be uncovered when the cleaning sheet is used to perform cleaning.

The cleaning sheet is preferably used as a sheet-formed base to be employed in the cleaning method of a medical recording apparatus.

By a cleaning method, in accordance with the present invention, of a medical recording apparatus having a built-in adhesive roller, the user is allowed to carry out cleaning of the adhesive roller during a short time period and quickly resume operation without causing nonuniformity after cleaning.

A cleaning sheet in accordance with the invention can be applied in the above cleaning method, wherein the user is allowed to carry out cleaning of the adhesive roller of a medical recording apparatus having the built-in adhesive roller during a short time period and quickly resume operation without causing nonuniformity after cleaning.

### Preferred Embodiment

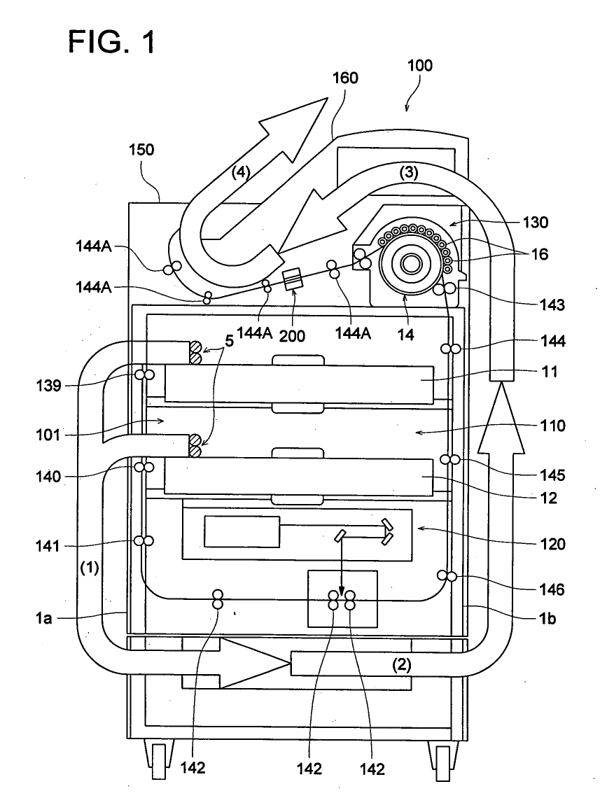

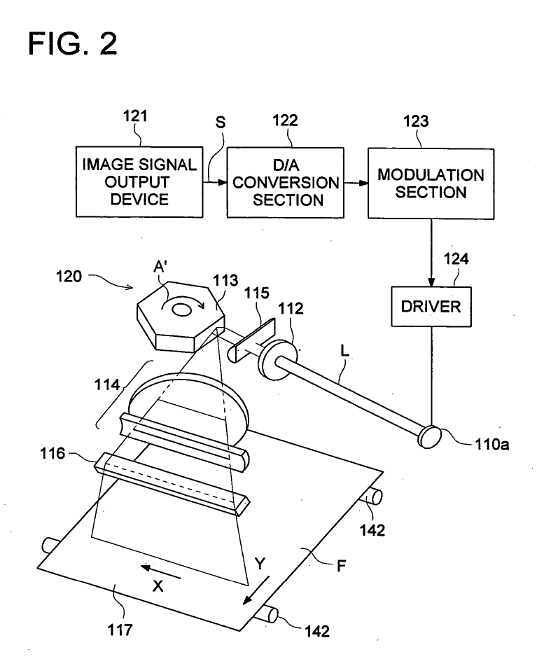

A most preferred embodiment in accordance with the invention will be described below, referring to the drawings. FIG. 1 is a schematic front view showing a medical recording apparatus to which a cleaning method in the present embodiment can be applied. FIG. 2 is a schematic diagram showing an exposure section of the medical recording apparatus in FIG. 1.

A medical recording apparatus 100, as shown in FIG. 1, includes a feeding section 110 having a first and second loading sections 11 and 12 for loading and mounting a package of a predetermined number of heat-developing photosensitive films (hereinafter, also referred to as “films”), which are a heat-developing photosensitive material in a sheet-form, and a conveying section 5 for conveying the films sheet by sheet to expose and develop the films. The apparatus 100 further includes an exposure section 120 for exposing the films supplied from the feeding section 110 and forming latent images, a heat-development section 130 for heat-developing the films formed with the latent images, and a cooling-and-conveying section 150 which has densitometer 200 for obtaining density data by measuring the density of developed films and has conveying rollers 144A.

Films in different sizes can be respectively loaded in the first and second loading sections 11 and 12 of the feeding section 110. From the first loading section 11 or the second loading section 12, films are conveyed one by one in arrow direction (1) by the conveying section 5 and pairs of conveying rollers 139, 140, and 141. The pairs of conveying rollers 139, 140, and 141 construct a first conveying unit that conveys the films downward to the exposure section 120.

Next, each film is horizontally conveyed in arrow direction (2) by pairs of rollers 142 and sub-scanned while a latent image is formed by irradiating laser beams on the film, according to diagnosis image signals in the exposure section 120.

Next, pairs of conveying rollers 146, 145, 144, and 143 convey the film in arrow direction (3). The pairs of conveying rollers 146, 145, 144, and 143 construct a second conveying unit to convey the film formed with the latent image upward toward the heat-development section 130.

Then, the latent image of the film is visualized by the heat-development section 130, conveyed to arrow direction (4) by pairs of conveying rollers 144A, cooled by the cooling-and conveying section 150, and ejected to an ejection section 160.

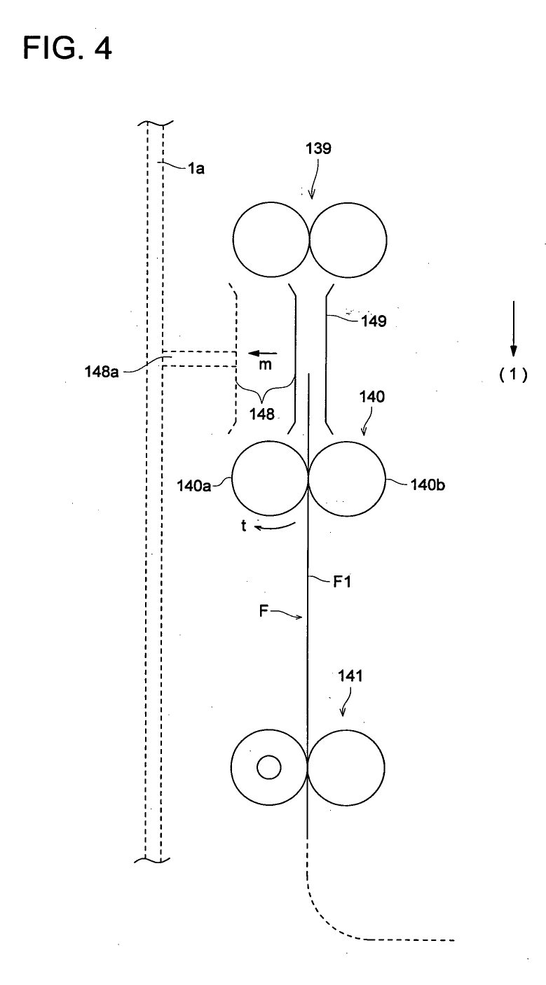

Herein, in FIG. 1, the emulsion side F1 (see FIG. 4) of the film faces the right at the position of the pairs of conveying rollers 139, 140, and 141, faces upward at the position of the pairs of conveying rollers 142 of the exposure section 120, and faces the left at the position of the pairs of conveying rollers 146, 145, 144, and 143.

Next, the exposure section will be described below. As shown in FIG. 2, the exposure section 120 polarizes a laser beams L, which has been intensity modulated according to a diagnosis image signals S, by a rotational polygonal mirror 113, and main scans the film F. The exposure section also sub scans the film F in such a manner that the film F is moved relative to the laser beam L in a direction approximately orthogonal to the main scanning direction. The latent image is formed in this way on the film F by the use of the laser beam L.

The structure of the exposure section 120 will be specifically described below. In FIG. 2, image data having been output from an external image signal output device 121 is received through a network or the like, and the diagnosis image signal S being the digital signal of the diagnosis image data is converted into an analog signal by a D/A conversion section 122 and input to a modulation section 123 including a modulation circuit. The modulation section 123 controls a driver 124 of a laser beam source section 110a, according to the analog signal, and the modulated laser beam L is irradiated from the laser beam source section 110a.

The laser beam L irradiated from the laser beam source section 110a passes through a lens 112, gets focused by a cylindrical lens 115 only in the up and down direction, and enters the rotational polygonal mirror 113 rotating in arrow direction A′, in the figure, as a line image orthogonal to a drive shaft of the mirror. The rotational polygonal mirror 113 reflects and polarizes the laser beam L in the main scanning direction, and the polarized laser beam L passes through fθ lens 114 of a combination of two lenses including a cylindrical lens, then gets reflected by a mirror 116 arranged on the optical path, extending in the main scanning direction, and main scans, repeatedly in arrow direction X, a scanning surface 117 of the film F conveyed (sub scanned) by the pairs of conveying rollers 142 in arrow direction Y. Namely, the laser beam L scans the entire area of the scanning surface 117 of the film F.

The cylindrical lens of the fθ lens 114 focuses the laser beam L having entered, on the scanning surface 117 of the film F only in the sub scanning direction, wherein the distance from the fθ lens 114 to the scanning surface is equal to the focal distance of the entire fθ lens 114. As described above, the fθ lens 114 including the cylindrical lens and the mirror 116 are provided in the exposure section 120, and the laser beam L is focused on the rotational polygonal mirror 113 only in the sub scanning direction. Therefore, even when the rotational polygonal mirror 113 inclines or its axis deviates, the scanning position by the laser beam L does not deviate in the sub scanning direction on the scanning surface 117 of the film F, allowing it to form scan lines at a constant pitch. The rotational polygonal mirror 113 has the advantage of scan stability compared with other optical polarizers such as a galvanometer mirror. In such a manner, a latent image of a diagnosis image based on diagnosis image signal S is formed on the film. F.

The heat-development section 130 in FIG. 130 includes a heat dram 14 serving as a heating member which holds the film F in close contact with its circumferential surface and is capable of heating and rotating the film. In the inner surface of the heat dram 14, a heater is arranged which generates heat and is temperature controlled by electrical current flow control. Outside the heat dram 14, several rotatable facing rollers 16 with a smaller diameter than that of the heat dram 14 are provided to be in contact with the heat dram 14, serving as guide members and press members, wherein the rollers 16 are disposed parallel to the heat dram 14, facing it.

The heat dram 14 conveys the film F formed with the latent image described above in a state of sandwiching the film F with the plural facing rollers 16, while heating and rotating the film F. Thus, by maintaining the film F at or higher than a predetermined lowest heat-development temperature for a predetermined heat-development time period, the heat dram 14 forms a latent image on the film F as a visible diagnosis image. Herein, the lowest heat-development temperature is the lowest temperature at which heat-development of the latent image formed on the film F begins, and is 95° C. or higher, for example. The heat-development time period is a time during which the film F is to be maintained at the lowest heat-development temperature or higher so that the latent image of the film F is developed for desired development characteristics.

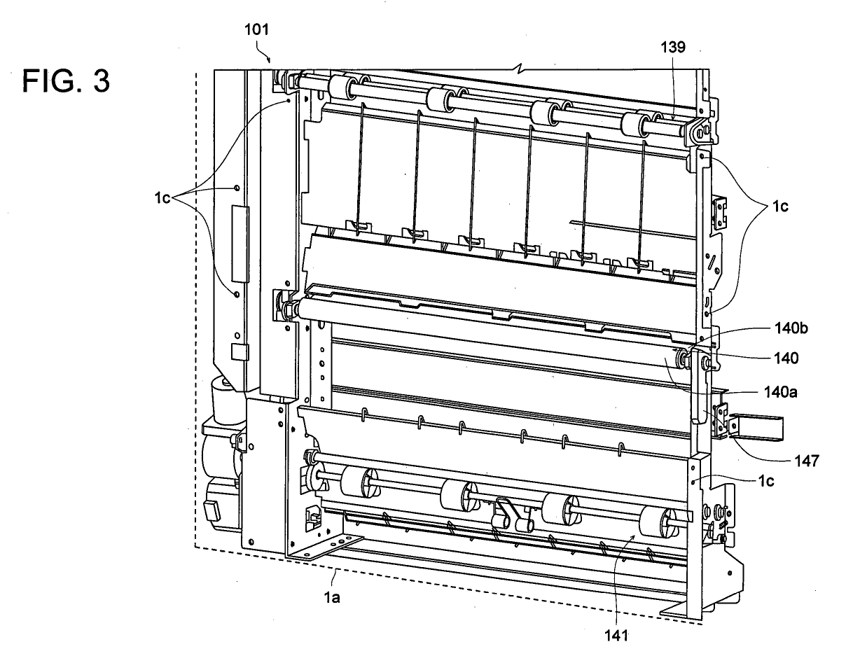

Next, a structure for cleaning operation of the adhesive roller disposed as one of the pair of conveying rollers 140 of the medical recording apparatus 100 in FIG. 1 will be described, referring to FIGS. 3 and 4. FIG. 3 is a perspective view showing the main part in the state where the side cover member is released from the housing of the medical recording apparatus in FIG. 1. FIG. 4 is a schematic side view of the pairs of conveying rollers 139, 140, and 141 (the first conveying unit) in FIG. 1.

As shown in FIG. 1, in a housing 101 of the part under the heat-developing section 130 of the medical recording apparatus 100, the first loading section 11, the second loading section 12, and the exposure section 120 are disposed one above another in this order. A side cover member 1a and 1b provided on both sides of the housing 101 are fixed to the housing 101 with screws. Herein, as illustrated by dashed lines in FIG. 3 for example, the side cover member 1a is fitted to plural screw holes 1c formed on the housing 101 with screws so that the inside the cover member 1a is light shielded. By releasing the fixing screws, the side cover members 1a and 1b can be removed to open inside the cover members. Herein, a releasable system including a known locking mechanism and a solenoid for releasing may be employed for the side cover members 1a and 1b, wherein the solenoid is controlled by a controller, not shown, so that the inside of the cover members is automatically released.

As shown in FIG. 1, 3 and 4, the pair of conveying rollers 140 disposed on the downstream side of the pair of conveying rollers 139 includes a drive roller 140a which is driven rotationally in one rotation direction t and an adhesive roller 140b which is a driven roller, and conveys the film F conveyed from the pair of conveying rollers 139, in direction (1) downward in FIGS. 1 and 4. Further, for cleaning, an operation lever 147 is fitted to one end of the shaft of the adhesive roller 140b, as shown in FIG. 3, and the operation lever 147 is operated so that the drive roller 140a is rotated.

The drive roller 140a of the pair of conveying rollers 140 is made of a resin material, and the adhesive roller 140b has adhesion at the roller surface. The adhesive roller 140b can be, for example, a butyl rubber adhesive roller, a silicon rubber adhesive roller, a urethane rubber adhesive roller, or a styrene elastomer adhesive roller, but is not limited to these. The adhesive roller 140b is disposed inside the housing 101 to come in contact with the emulsion side F1 of the film F. Foreign matters such as dust tend to adhere to the surface of the adhesive roller 140b. Herein, as shown in FIG. 4, foreign matters such as dust and the like adhered to the emulsion side F1 of the film F can be effectively removed in such a manner that the adhesive roller 140b contacts with the emulsion side F1.

The film F having been conveyed from the pair of conveying rollers 140 is turned from the vertical direction to the horizontal direction after the pair of conveying rollers 141 which is disposed downstream side of the pair of conveying rollers 140, and conveyed by the pairs of conveying rollers 142 in the exposure section 120, while being sub scanned.

As shown in FIG. 4, a pair of guide members 148 and 149 is arranged on the upstream side of the pair of conveying rollers 140 in such a manner that the guide members face the respective surfaces of the film F being conveyed, thereby preventing dust and the like from adhering to the film F, to the possible extent. The guide member 148 is located on the side of the side cover member 1a, and the guide member 149 is located on the side inside the housing 101.

As illustrated by the dashed lines in FIG. 4, the guide member 148 is connected to the side cover member 1a at a connection section 148a, wherein when the side cover member la is removed, as shown in FIG. 3, the guide member 148 is also removed integrally with the side cover member 1a from the position shown by the solid lines, in FIG. 4, in direction m toward the position shown by the dashed lines.

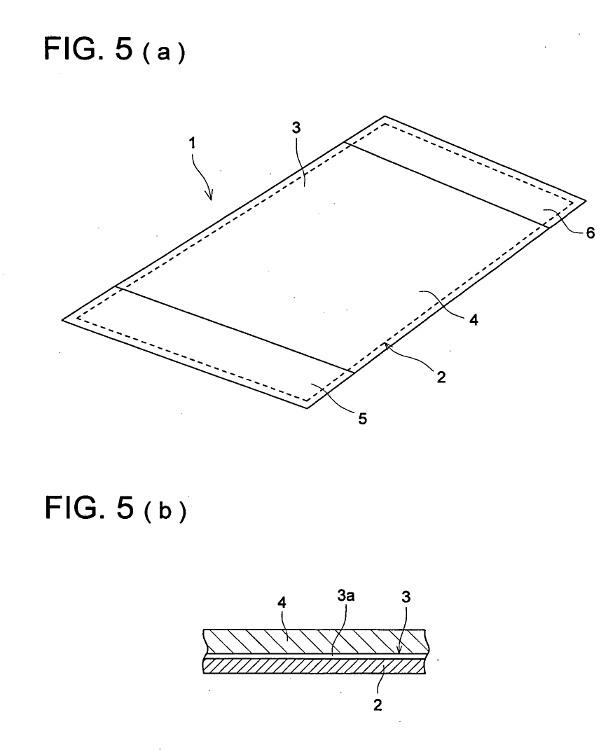

Next, it will be described about a cleaning sheet for cleaning the adhesive roller 140b of the pair of conveying rollers 140 of the medical recording apparatus 100, referring to FIGS. 5A and 5B. The FIGS. 5A and 5B are respectively a perspective view and a fragmentary enlarged sectional view of the cleaning sheet in the present embodiment.

As shown in FIGS. 5A and 5B, the cleaning sheet 1 includes a flexible sheet-formed base 2 in a rectangular shape, an adhesive layer 3a which is provided to make one surface of the flexible sheet-formed base 2 serve as an adhesive surface 3, and auxiliary members 5 and 6 which are provided on the adhesive surface 3, with a predetermined width along the both edges of the flexible sheet-formed base 2, to improve the rigidity of flexible sheet-formed base 2.

The flexible sheet-formed base 2 can be, for example, a PET sheet, of which thickness may be set to approximately 50 am, for example. The adhesive layer 3a is formed such that the adhesive surface 3 has an adhesive force greater than that of the surface of the adhesive roller 140b. The adhesion of the adhesive surface 3 is preferably five to ten times as strong as that of the surface of the adhesive roller 140b. The adhesive layer 3a can be made of an acrylic solvent adhesive, for example, and preferably has an adhesive of approximately 12 to 15 N/25 mm (by JIS Z 0237).

As shown in FIG. 5A, the auxiliary members 5 and 6 are glued disposed on both edge sides of the adhesive surface 3 of the flexible sheet-formed base 2, sticking out a little from the adhesive surface 3, as shown in FIG. 5A. Such a structure enables higher rigidity of the cleaning sheet at the both edge sides, by which the user can grip a front edge part of the cleaning sheet with one hand and insert the sheet into a nip portion of the adhesive roller. Further, in inserting the front edge into the nip portion of the adhesive roller, even repeating insertion twice or three times, for example, the surface of the adhesive surface 3 is not uncovered at the edge portions, and the edge portions are surface-slidable layers of the auxiliary member 5 or 6, thus causing no problem. Once the thickness of a PET sheet is determined, a desired rigidity can of course be obtained by selecting the thicknesses of the auxiliary members 5 and 6 properly. Further, it is also possible to make both sides of the flexible sheet be adhesive surfaces and provide an auxiliary member described above on both sides. Confusing the front side and back side of the flexible sheet-formed base can be prevented in this way. In this case, two auxiliary members function at either edge portion, and accordingly the rigidity increases.

The auxiliary members 5 and 6 are made, for example, in such a manner that both surfaces of a high quality plain paper sheet are polyethylene laminated and one surface is subjected to peeling. Further, since the auxiliary members 5 and 6 slightly stick out from the adhesive surface 3, it is prevented that the adhesive surface 3 adheres to a part other than the surface of the adhesive roller 140b, when engaging the cleaning sheet with the adhesive roller 140b, and prevented that handling becomes difficult.

A cover sheet 4 of the same material as the auxiliary members 5 and 6 is arranged between the auxiliary members 5 and 6. The cover sheet 4 is peeled off to uncover the adhesive surface 3 when the cleaning sheet 1 is used for cleaning.

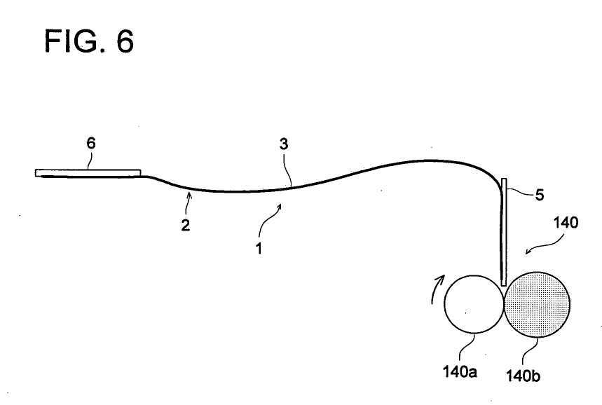

Next, the method of cleaning the adhesive roller 140b, in FIGS. 1, 3, and 4, by the use of the cleaning sheet 1 in FIG. 5, for maintenance of the medical recording apparatus 100 in FIG. 1 will be described, referring to FIG. 6. FIG. 6 is a schematic side view showing a state where the pair of conveying rollers 140 in FIG. 4 is cleaned by the cleaning sheet 1 in FIG. 5.

When performing cleaning of the adhesive roller 140b of the pair of conveying rollers 140 shown in FIG. 1, 3, and 4, first, the screws of the side cover members 1a are released from the housing 101 of the medical recording apparatus 1, or the side cover member 1a is released by inputting cover releasing data via an operation section (not shown) in the case of automatic releasing system with a solenoid. Herein, when the side cover member 1a is released, the guide member 148 is also removed together. Thus, as shown in FIG. 3, a part of the drive roller 140a of the pair of conveying rollers 140 and a part of the adhesive roller 140b are uncovered.

Next, as shown in FIG. 6, the user brings the cleaning sheet 1, in FIG. 5, close to the nip section of the pair of conveying rollers 140 such that the auxiliary member 5 is on the adhesive roller 140b side. Herein, the user grips by hand the auxiliary member 5, having a higher rigidity at the edge portion of the cleaning sheet 1, and thus can easily insert the cleaning sheet 1 toward the nip section of the pair of conveying rollers 140. Further, the auxiliary member 5 is sticking out from the adhesive surface 3 during the insertion. Therefore, the front edge of the adhesive surface 3 does not adhere to other portions, enabling easy cleaning.

Next, the user intermittently rotates the drive roller 140a by the operation lever 147 in one direction t against the load of the drive system including the self holding force of a rotor and a stator of a stepping motor which is the driving source of the drive roller 140a. In such a manner, the cleaning sheet 1 is sandwiched by the pair of conveying rollers 140 and moved downward, in FIG. 6, and the adhesive surface 3 of the cleaning sheet 1 is engaged with the adhesive roller 140b to be moved for a predetermined distance being approximately the length of the adhesive surface 3. Herein, the flexible sheet-formed base 2 can follow the surface of the adhesive roller 140b along the roller axis direction due to the flexible characteristic of the sheet. Therefore, the adhesive surface 3 is engaged with the surface of the adhesive roller 140b uniformly along the roller axis direction, and accordingly wrinkles are not created, allowing uniform cleaning.

Next, the user rotates the drive roller 140a in reverse direction, sandwiching the cleaning sheet 1 with the pair of conveying rollers 140, and thereby moves the sheet 1 upward, in FIG. 6. In this way, the user returns the cleaning sheet 1 to where it was while engaging the adhesive surface 3 with the adhesive roller 140b. The user repeats this reciprocal operation twice or three times, for example, to clean the entire circumferential surface of the adhesive roller 140b. Thereafter, the user rotates the drive roller 140a in reverse direction to separate the edge portion of the flexible sheet-formed base 2 from the nip section of the adhesive roller 140b (in the invention, this operation is referred to as “releasing the engagement between the sheet-formed base and the adhesive roller”). Thus, it is possible to transfer foreign matters from the surface of the adhesive roller 140b onto the adhesive surface 3 of the cleaning sheet 1, and thereby uniformly clean the surface of the adhesive roller 140b. Herein, instead of the operation described above, if the user forcibly pulls out the cleaning sheet while keeping the nip section in the nip state, or opens the nip section by hand to pull out the cleaning sheet, the foreign matters having been removed once may be unpreferably transferred again to the adhesive roller 140b.

Next, the user removes the cleaning sheet 1 from the nip section, and thereby cleaning is completed. After removing foreign matters such as dust from the surface of the adhesive roller 140b in this way, when the user closes the cover la, it immediately becomes possible to print a diagnosis image.

Further, according to the study by the inventors, a transfer rate from the adhesive roller 140b to the cleaning sheet 1 is higher if the motion speed of the cleaning sheet 1 is lower, for the same adhesive force. Taking this into account, after the user opens the cover corresponding to the adhesive roller of the pair of conveying rollers 140 of the conveying system which is from the feeding section 110 to the exposure section 120, the user preferably moves (rotates) the adhesive roller itself via the operation lever 147 or runs the drive system of the conveying system for motion (rotation), relatively slowly. Further, this is also preferable because power supply to driven components is usually turned off, from the viewpoint of safety, while the cover is open.

Further, the conveying distance of the cleaning sheet 1 is preferably not shorter than the circumferential length of the adhesive roller 140b. The conveying distance is also preferably a length long enough which does not make it difficult to remove the cleaning sheet 1, which could happen when the cleaning sheet continues to be moved manually and the edge of the cleaning sheet 1 goes downstream side too far.

Further, according to the cleaning method of the adhesive roller 140b with the cleaning sheet 1, radiologists or the like to be an operator do not need to directly touch the adhesive roller for maintenance, and only have to insert the front edge of the cleaning sheet 1 to the nip section of the pair of conveying rollers 140. Therefore, irregularities are not created due to wiping by a worker, and uniform cleaning can be achieved.

Still further, in the case where a pair of conveying rollers are structured by adhesive rollers provided on both the emulsion side and the backcoat side of a film, an adhesive surface described above is preferably arranged on both surfaces of a flexible sheet-formed base 2 and the auxiliary member is preferably provided at each edge portion of both surfaces.

As stated above, it is possible to clean the surface of the adhesive roller 140b by the cleaning sheet 1 uniformly, according to the method in the present embodiment. Therefore, a user is allowed to clean the adhesive roller of the medical recording apparatus 100 having the adhesive roller built-in, during a short time, and to resume operation of the apparatus shortly after cleaning, without irregularities after the cleaning. Further, foreign matters on the emulsion side, being the image forming surface, can be sufficiently removed. Accordingly, it is possible to surely prevent generation of image defects such as white spots on a finished image which could affect diagnosis accuracy otherwise.

Although a most preferable embodiment to carry out the invention has been described above, the invention is not limited to this, and various modifications can be made within the scope and spirit of the invention. For example, adhesive rollers may be arranged for the pairs of conveying rollers 139,-141, and the like, to more effectively remove foreign matters from the emulsion side of a film.

Further, adhesive rollers, similar to those in FIG. 4, may also be disposed on the second conveying unit side (conveying roller pairs 146, 145, 144, and 143), with the same arrangement as that in FIG. 4 to carry out cleaning of the adhesive rollers sufficiently and uniformly by the cleaning sheet 1. Thus, it is prevented that a film is heated while having foreign matters such as dust, adhered thereto which could form defects otherwise.

1. A cleaning method of a medical recording apparatus, wherein the recording apparatus comprises:
a film loading unit for holding a stack of photosensitive sheet films and feeding each sheet film one at a time;
a conveying unit for conveying each sheet film, the conveying unit including an adhesive roller which has an adhesive force and works as removing foreign matters from a surface of the sheet film;
an exposure unit for forming a latent image corresponding to a diagnosis image signal on the surface of each conveyed sheet film; and
a cover unit capable of keeping the film loading unit, the conveying unit, and the exposure unit in a light shielded state, and capable of opening a vicinity of the adhesive roller of the conveying unit,
the method comprising the steps of:
opening the vicinity of the adhesive roller by the cover unit;
engaging a cleaning sheet with the adhesive roller, wherein the cleaning sheet has an adhesive surface on at least one side of the cleaning sheet which applies a greater adhesive force than the adhesive force of the adhesive roller;
rotating the adhesive roller, while keeping the engagement for conveying the cleaning sheet;
transferring the foreign matters from the adhesive roller which have been adhered to the roller in recording on the sheet films, to the surface of the cleaning sheet during the conveyance of the cleaning sheet; and
removing the cleaning sheet with the foreign matters.

2. The method of claim 1, wherein the engagement between the cleaning sheet and the adhesive roller is released after the transfer of the foreign matters to the surface of the cleaning sheet.

3. The method of claim 1, wherein the adhesive roller further has a nip roller function to convey each sheet film.

4. The method of claim 1, wherein the adhesive roller is rotated in normal and reverse directions after the cleaning sheet and the adhesive roller are engaged with each other.

5. The method of claim 1, wherein the adhesive roller comes in contact with the surface, of each sheet film one at a time, on which the latent image is formed.

6. A cleaning sheet for cleaning an adhesive roller which is provided in a conveying system, of a medical recording apparatus, for conveying a photosensitive film sheet or a photostimulable phosphor sheet and is capable of transferring and removing foreign matters adhered to the film sheet or the phosphor sheet, the cleaning sheet comprising:
a flexible sheet-formed base having a flexibility to follow a surface of the adhesive roller along an axis direction of the adhesive roller;
an adhesive layer formed on at least one side of the flexible sheet-formed base to make an adhesive surface; and
an auxiliary member provided on the adhesive surface along at least one side-edge of the flexible sheet-formed base with a predetermined width for improving rigidity of the flexible sheet-formed base.

7. The cleaning sheet of claim 6, wherein a surface of the auxiliary member is slidable on a top surface.

8. The cleaning sheet of claim 6, wherein an edge portion of the auxiliary member is sticking out of the adhesive surface.

9. The cleaning sheet of claim 6, further comprising a cover sheet that covers the adhesive surface and can be removed so that the adhesive surface can be uncovered when the cleaning sheet is used to perform cleaning.

10. The cleaning sheet of claim 6, wherein the cleaning sheet is used as the cleaning sheet in the cleaning method of claim 1 of the medical recording apparatus.
